(19) United States
(12) Patent Application Publication
(10) Pub. No.: US 2026/0350463 A1
(43) Pub. Date: Nov. 5, 2026

(54) Model Merging in Distributed Stream Clustering

(71) Applicant: CrowdStrike, Inc., Sunnyvale, CA (US)

(72) Inventor: Pradeep Kumar Swain, Cary, NC (US)

(73) Assignee: CrowdStrike, Inc., Sunnyvale, CA (US)

(21) Appl. No.: 19/195,749

(22) Filed: May 1, 2025

(51) Int. Cl. G06N 20/00; G06F 18/23

(52) U.S. Cl. CPC G06N 20/00; G06F 18/23

(57) ABSTRACT

A distributed stream clustering service clusters streaming data for fast and efficient analysis. A stream clustering model is distributed to computer nodes, and the computer nodes use the stream clustering model to cluster the streaming data into micro-clusters. When a model divergence is determined, though, an updated stream clustering model is generated and distributed to the computer nodes. The computer nodes replace the stream clustering model with the updated stream clustering model and resume clustering the streaming data.

### BACKGROUND

The subject matter described herein generally relates to computers and to computer security and, more particularly, the subject matter relates to machine learning and to distributed stream clustering.

Streaming data has exploded. Smartphones, laptops, servers, and other computer devices are streaming massive amounts of data to/from the Internet. These big data streams must be analyzed in near real time to provide services. Stream clustering techniques, for example, have been used to analyze big data streams. Conventional stream clustering techniques, though, react too slow to rapid changes in streaming data.

### SUMMARY

Streaming data is clustered for fast and efficient analysis. A stream clustering model is distributed to computer nodes, and the computer nodes cluster the streaming data using the stream clustering model. As the streaming data changes, though, each computer node learns, retrains, and thus adapts to changes in the streaming data. Over time, then, the computer nodes process the streaming data using different model versions of the stream clustering model. A distributed stream clustering service, however, overcomes this model drift or variation by updating the stream clustering model. As the computer nodes cluster the streaming data, the distributed stream clustering service instructs the computer nodes to also monitor and report micro-cluster data representations. The micro-cluster data representations describe micro-clusters generated by each computer node as the streaming data is processed. The distributed stream clustering service analyzes the micro-cluster data representations for various indications of model divergence. When the model divergence is determined, the distributed stream clustering service generates and distributes an updated stream clustering model that overcomes, or compensates for, the model drift.

### BRIEF DESCRIPTION OF THE SEVERAL VIEWS OF THE DRAWINGS

The features, aspects, and advantages of model merging in distributed stream clustering are understood when the following Detailed Description is read with reference to the accompanying drawings, wherein:

FIGS. 1-3 illustrate simple examples of clusteral prediction;

FIGS. 4-6 illustrate examples of clusterer lifecycle;

FIGS. 7-8 illustrate more detailed examples of a distributed stream clustering service;

FIGS. 9-10 illustrate more examples of the clusterer lifecycle;

FIG. 11 illustrates more examples of model divergence;

FIGS. 12-18 illustrate examples of the model divergence;

FIGS. 19-21 illustrate examples of cybersecurity event monitoring;

FIGS. 22-23 illustrate examples of localized cybersecurity event monitoring;

FIGS. 24-26 illustrate examples of methods or operations that cluster streaming data; and

FIG. 27 illustrates a more detailed example of an operating environment.

### DETAILED DESCRIPTION

Some examples relate to analysis of streaming data. As we browse the Internet, read tweets, watch INSTAGRAM®, or use other software applications, our devices are streaming data to and from the Internet. This streaming data is used to monitor our content selections, to deliver advertisements, and to provide many other services. Indeed, because Internet usage has exploded, advanced machine learning techniques are used to process and to mine huge amounts of Big Data. So-called distributed stream clustering, for example, is a technique that finds similarities in Big Data. Distributed stream clustering uses a machine learning model to quickly and to efficiently group similar data into buckets (called clusters). Simply put, the machine learning model reads the streaming data and very quickly predicts which bucket (i.e., which cluster) best describes the streaming data. Internet searches for Taylor Swift, for example, may be clustered together. Tweets mentioning the New York Yankees may be clustered together. These are only very simple examples. In actual practice, the machine learning model may generate many different clusters to categorize huge amounts of the streaming data.

Sometimes, though, the machine learning model needs an adjustment. Distributed stream clustering may use many computers to analyze the huge amounts of the streaming data. Each computer runs the machine learning model and groups similar data into the common buckets/clusters. Over time, though, the computers can change the machine learning model. As each individual computer processes the streaming data, each computer may slightly change or tweak the machine learning model. In perhaps just a few hours or days, for example, the many different computers may be running different versions of the machine learning model. These different versions have each drifted from the original/baseline machine learning model.

A distributed stream clustering service, however, overcomes this model drift or variation. As the computers cluster the streaming data, the distributed stream clustering service instructs the computers to also monitor and to report data describing their clusters. The distributed stream clustering service analyzes the data describing the clusters and looks for indications of model divergence. When the distributed stream clustering service finds evidence of model divergence, the distributed stream clustering service generates an updated machine learning model that overcomes, or compensates for, the model drift. The distributed stream clustering service then instructs the computers to stop using the old machine learning model and to, instead, start using the updated machine learning model.

The distributed stream clustering service may also detect cybersecurity attacks. As we all know, nearly every day there is another hack that steals account passwords and other personal information. Our inboxes often contain emails or texts that contain malicious links. Computer viruses can ruin our devices. The distributed stream clustering service, however, may also be used to protect our smartphones, laptops, and other computer devices from cybersecurity attacks. As our devices operate, our devices stream data via the Internet to the distributed stream clustering service. The streaming data, in particular, describes events requested of an operating system. The distributed stream clustering service instructs the many computers to analyze the events and to identify their corresponding clusters. Most clusters, for example, are associated with known safe/normal computer behavior. Some clusters, though, are associated with abnormal computer behavior. So, as the events are received, the machine learning model predicts whether the events are associated with safe/normal clusters or associated with abnormal clusters. Again, though, as the computers analyze the events, each computer may slightly change the machine learning model. In perhaps just a few hours or days, the many different computers may be running different versions of the machine learning model. The distributed stream clustering service, however, overcomes this model drift by generating the updated machine learning model. When the different versions of the machine learning model diverge too much, the distributed stream clustering service instructs the computers to stop using the old machine learning model and to, instead, start using the updated machine learning model.

Model merging in distributed stream clustering will now be described more fully hereinafter with reference to the accompanying drawings. Model merging in distributed stream clustering, however, may be embodied in many different forms and should not be construed as limited to the examples set forth herein. These examples are provided so that this disclosure will be thorough and complete and fully convey model merging in distributed stream clustering to those of ordinary skill in the art. Moreover, all the examples of model merging in distributed stream clustering are intended to encompass both structural and functional equivalents thereof. Additionally, it is intended that such equivalents include both currently known equivalents as well as equivalents developed in the future (i.e., any elements developed that perform the same function, regardless of structure).

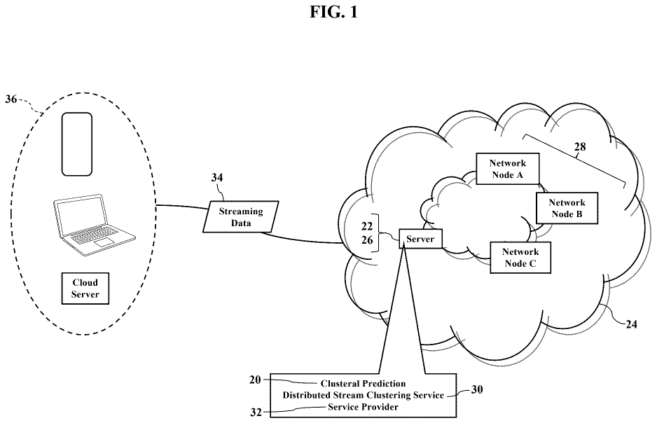

FIGS. 1-3 illustrate simple examples of a clusteral prediction 20. A computer system 22 operates in a cloud computing environment 24. FIG. 1 illustrates the computer system 22 as a server 26. The computer system 22, though, may be another processor-controlled device, as later paragraphs will explain. In this example, the server 26 communicates via the cloud computing environment 24 (e.g., public Internet, private network, and/or hybrid network) with other servers, devices, computers, or other networked nodes 28 operating within, or affiliated with, the cloud computing environment 24. The cloud computing environment 24 provides a distributed stream clustering service 30 on behalf of a service provider 32. The distributed stream clustering service 30 receives streams of digital data (e.g., streaming data 34). While the streaming data 34 may originate from other network locations, FIG. 1 illustrates customers and users of the distributed stream clustering service 30. That is, smartphones, laptops, and other client devices 36 send the streaming data 34 to the cloud computing environment 24. The cloud computing environment 24 disperses or distributes the streaming data 34 to the networked nodes 28 for analysis.

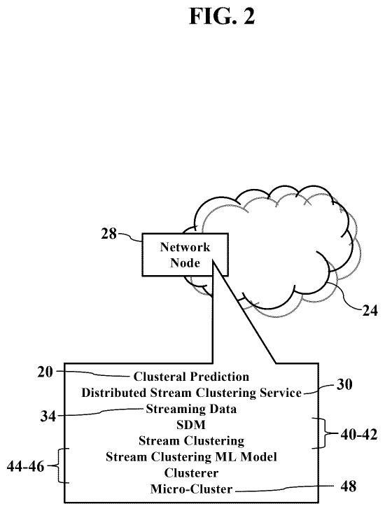

FIG. 2 illustrates more details of the distributed stream clustering service 30. The cloud computing environment 24 may route all the streaming data 34 to the networked node 28 for analysis. More likely, though, the cloud computing environment 24 balances the processing loads and distributes portions or packets to the different networked nodes 34, based on availability. However the streaming data 34 is allocated, the streaming data 34 may represent computer logs, click-stream data, tweets, movies/music/messages, and whatever other electronic data is streamed from the client devices 36 (illustrated in FIG. 1). Each individual networked node 28 performs near real time stream data mining (or SDM) 40 on one or more sequential data points or instances representing its streaming data 34. While other stream data mining techniques may be used, FIG. 2 illustrates stream clustering 42 as a fast and efficient learning and prediction scheme. Each networked node 28, for example, processes its streaming data 34 by executing a stream clustering machine learning (or ML) model 44 (sometimes called a clusterer 46). The stream clustering machine learning model 44 is initially pre-trained to generate one or more micro-clusters 48. Each micro-cluster 48 describes groups or clusters of the streaming data 34 having a common characteristic, value, category, classification, or other label. The distributed stream clustering service 30 then distributes the pre-trained stream clustering machine learning model 44 to the networked nodes 28. Once each networked node 28 downloads and installs the pre-trained stream clustering machine learning model 44, each networked node 28 then analyzes its streaming data 34 using the pre-trained stream clustering machine learning model 44. Each networked node 28, for example, generates its clusteral prediction 20 initially using the stream clustering machine learning model 44. That is, the stream clustering machine learning model 44 analyzes the incoming streaming data 34 in near real time and predicts which micro-cluster 48 best suits or characterizes the data point(s) or instance(s).

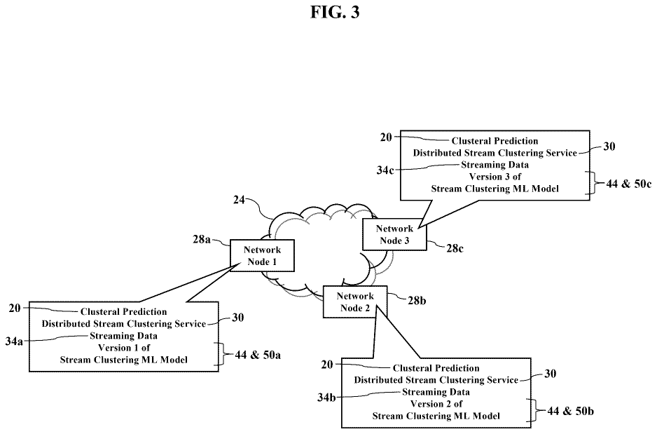

As FIG. 3 illustrates, each networked node 28 also learns with time and experience.

The distributed stream clustering service 30 may service hundreds, thousands, or even millions of the client devices 36 (illustrated in FIG. 1). Each day, then, the distributed stream clustering service 30 may receive many petabytes or more of the streaming data 34. Because so much streaming data 34 is received, the cloud computing environment 24 may have hundreds or even thousands of servers, routers, switches, and other computer networked nodes 28 analyzing portions of the streaming data 34. Such a large number of networked nodes 28 is too difficult to illustrate, so FIG. 3 merely shows a simple example. Three (3) networked nodes (illustrated as reference numerals 28a-c) receive and process their corresponding portion of the streaming data 34a-c. As each networked node 28a-c processes its streaming data 34a-c, each individual node 28 may also continuously learn from its streaming data 34a-c and independently update or refine its corresponding stream clustering machine learning model 44a-c. Over time and experience, then, the networked nodes 28 may develop differing localized versions 50a-c of the initial/base stream clustering machine learning model 44, despite a common starting point.

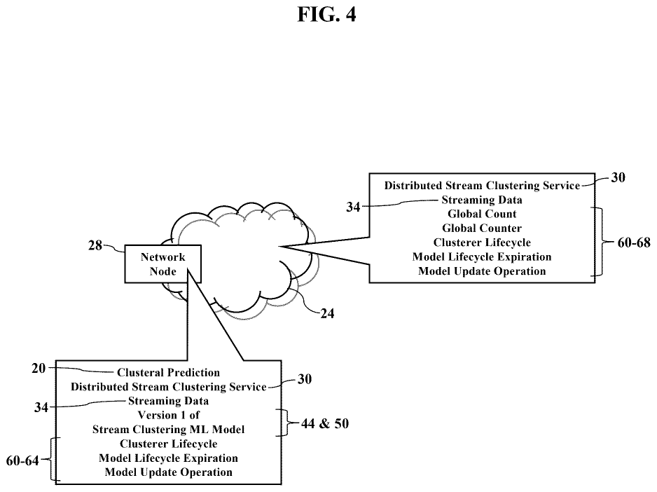

FIGS. 4-6 illustrate examples of a clusterer lifecycle 60. The distributed stream clustering service 30 initially distributes the pre-trained stream clustering machine learning model 44 to networked node 28. As the networked node 28 receives its streaming data 34, the networked node 28 independently updates its localized model 44, thus evolving into its localized version 50 of the initial/base stream clustering machine learning model 44. As one may understand, over time and experience the individual node 28 learns from its streaming data 34 and independently updates or refines its corresponding stream clustering machine learning model 44. Each networked node 28 eventually (perhaps even quickly) develops a differing localized version 50 of the initial/base stream clustering machine learning model 44. To address the potential drift among these localized versions 50, the distributed stream clustering service 30 may implement the clusterer lifecycle 60. The clusterer lifecycle 60 defines a model lifecycle expiration 62 of the stream clustering machine learning model 44 (i.e., the pre-trained clusterer 46 illustrated in FIG. 2) that was distributed/downloaded to the networked nodes 28. When the distributed stream clustering service 30 determines the model lifecycle expiration 62, the distributed stream clustering service 30 triggers and implements a clustering model update operation 64.

The clusterer lifecycle 60 ensures that the stream clustering machine learning model 44 is regularly updated. The clusterer lifecycle 60, for example, may be determined based on a global count 66 of the streaming data 34 processed by the networked nodes 28. The clusterer lifecycle 60, in other words, may count the total number of streaming data points that are received/observed by the distributed stream clustering service 30 and dispersed or distributed to the networked nodes 28. When the distributed stream clustering service 30 initially distributes the pre-trained/baseline stream clustering machine learning model 44 to the networked nodes 28, the distributed stream clustering service 30 may initialize a global counter 68 at an initial value (such as zero). As the distributed stream clustering service 30 then begins receiving and distributing the streaming data 34 to the networked nodes 28, the distributed stream clustering service 30 then begins incrementing the global counter 68 to its final value. The distributed stream clustering service 30, as an example, may increment the global counter 68 in response to each byte of the streaming data 34 that is received by the distributed stream clustering service 30. The distributed stream clustering service 30, as another example, may increment the global counter 68 in response to each operating system event described by the streaming data 34 (as later paragraphs will explain). Whatever the global counter 68 represents, when the global counter 68 reaches its final value, the clusterer lifecycle 60 expires and the clustering model update operation 64 may be triggered.

The clusterer lifecycle 60 may be durable. The global counter 68, for example, may be maintained in a distributed cache memory, perhaps which is external to the networked nodes 28 and/or to the distributed stream clustering service 30. Should any networked node 28, or even the distributed stream clustering service 30, go down or get terminated (for whatever reason), the current value of the global counter 68 will persist. Each networked node 28, as another example, may maintain a local (in-memory) counter, which is incremented when the node 28 receives an operating system event or other streaming data 34. When the local counter, for example, reaches multiples of 100, the node 28 may call the distributed cache, which increments the global counter 68 by 100. This localized count-and-call scheme prevents calling external cache for each and every operating system event, or other streaming data 34, which would overwhelm the distributed cache due to extremely high streaming data volumes. As a further example, the distributed cache may be a REDIS® cluster, which supports high concurrency and atomicity of operation. So, to get the counter value at any time, the distributed stream clustering service 30 calls the distributed cache.

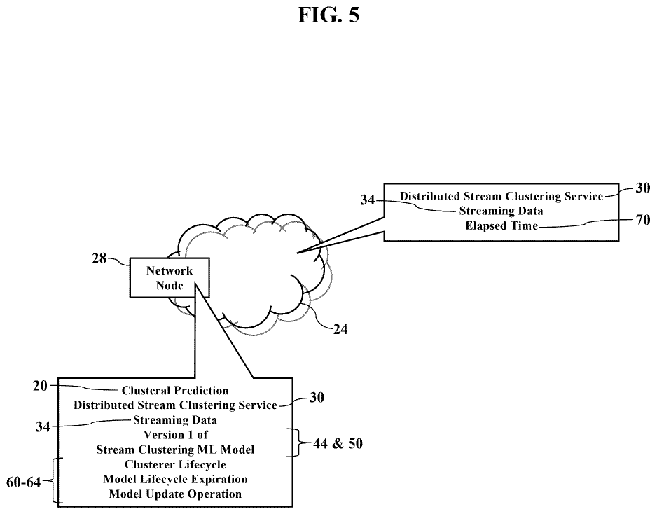

FIG. 5 illustrates a time-based clusterer lifecycle 60. The clusterer lifecycle 60 may additionally or alternatively expire after an elapsed time 70. When the distributed stream clustering service 30 initially distributes the stream clustering machine learning model 44 (i.e., the pre-trained clusterer 46 illustrated in FIG. 2) to the networked nodes 28, the distributed stream clustering service 30 may initialize a timer at an initial value (such as zero or the elapsed time 70). As the distributed stream clustering service 30 then begins receiving and distributing the streaming data 34 to the networked nodes 28, the distributed stream clustering service 30 begins incrementing/decrementing the timer to its final value after the elapsed time 70. When the timer expires at the elapsed time 70, the clusterer lifecycle 60 also expires, and the clustering model update operation 64 may be triggered.

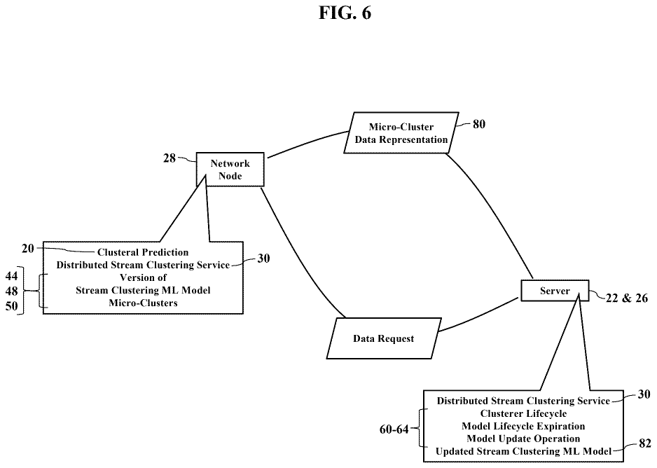

FIG. 6 illustrates the clustering model update operation 64. The clusterer lifecycle 60 ensures that the stream clustering machine learning model 44 is regularly/periodically updated. The clusterer lifecycle 60, for example, refreshes/replaces the stream clustering machine learning model 44 based on either/both the volume of new streaming data 34 (e.g. the global counter 68 data explained with reference to FIG. 4) and/or the passage of time (e.g., the elapsed time 70 explained with reference to FIG. 5), thus maintaining the model's relevance and accuracy. When the distributed stream clustering service 30 determines the model lifecycle expiration 62, the distributed stream clustering service 30 may be programmed to perform the clustering model update operation 64. The computer system 22 (again illustrated as the server 26), for example, may query each networked node 28 and retrieve one or more micro-cluster data representations 80 describing its localized micro-clusters 48. While the micro-clusters 48 may be represented using other data schemes, each micro-cluster 48 may be represented by its corresponding cluster feature vector (or CFV). The cluster feature vector mathematically summarizes the key characteristics of its corresponding micro-cluster 48. The server 26 thus collects the cluster feature vectors reported by the networked nodes 28 and performs a merge operation on the feature vectors. The server 26 may thus concatenate, sum, add, weight, average, or other operation to merge the cluster feature vectors. The server 26 may additionally or alternatively select important features. However the merge operation is determined, the clustering model update operation 64 combines the independently trained, differing localized versions 50 of the nodal stream clustering machine learning models 44. The clustering model update operation 64 thus generates an updated stream clustering machine learning model 82 by merging the micro-cluster data representations 80.

The new, updated stream clustering machine learning model 82 may be put into service. The distributed stream clustering service 30 redistributes the updated stream clustering machine learning model 82 to the networked nodes 28. Each networked node 28 may be further instructed to download and install the updated stream clustering machine learning model 82. The merged, updated stream clustering machine learning model 82 now becomes the new predictive base model in the next cycle. Each networked node 28, for example, begins generating its latest clusteral predictions 20 using the merged/latest updated stream clustering machine learning model 82. The clusterer lifecycle 60, and the clustering model update operation 64, thus ensure that the distributed stream clustering service 30 continuously evolves and adapts to new patterns in the streaming data 34.

The distributed stream clustering service 30 may thus have online aspects and offline aspects. The nodal learning and prediction aspects, for example, are performed online and in near real time. The clustering model update operation 64, though, may be performed offline. The distributed stream clustering service 30 creates the durable clusterer 46 (illustrated in FIG. 2) for the life of a given input type with a distinct set of hyperparameters. The optimal hyperparameters are determined through offline experiments prior to deployment. Once the optimal hyperparameters are finalized, the hyperparameters are used in the distributed, nodal training and inference for the stream clustering 42. This approach ensures that the stream clustering machine learning model 44 remains relevant and effective over time, even as the underlying data patterns change.

The distributed stream clustering service 30 may implement other design features. To handle the potential issue of concept drift, where the underlying distribution of the streaming data 34 changes over time, the distributed stream clustering service 30 may employ other design strategies. Within the clusterer lifecycle 60 of the clusterer version (i.e., for a given set of hyperparameters), the stream clustering machine learning model 44 (e.g., the clusterer 46) may adhere to its original definition. During merging cycles, the distributed stream clustering service 30 may preserve cluster identities of its base clusterer 46. Merging may only add new micro-clusters 48 and may not remove any previously or historically generated/predicted micro-clusters. During distributed training cycles, micro-cluster centers may be allowed to change, but only within a specified radius/distance threshold. This ensures that there may be no significant drift between previously predicted micro-clusters 48 and the same micro-clusters 48 in future iterations.

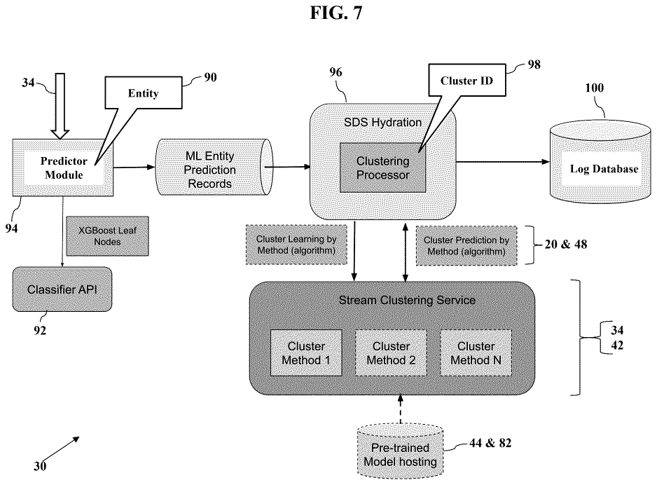

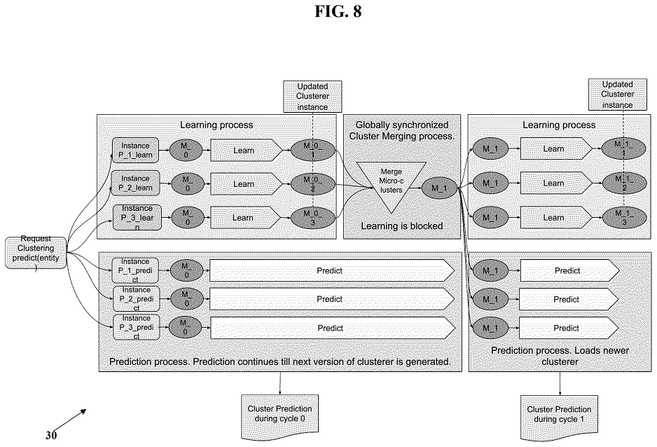

FIGS. 7-8 illustrate more detailed examples of the distributed stream clustering service 30. FIG. 7 illustrates a service architecture, while FIG. 8 illustrates a methodical strategy that combines distributed learning and prediction to alleviate the need for offline learning and deployment. The distributed stream clustering service 30 predicts an affinity or entitative relationship (e.g., the clusteral prediction 20) between the streaming data 34 and one or more of the micro-clusters 48. Each data point within the streaming data 34, in other words, may have a common association with its corresponding micro-cluster(s) 48. The data point within the streaming data 34 and the micro-cluster(s) 48 may share a common entity 90. In cybersecurity defense, for example, the common entity 90 may be an incident of attack (or IoA). The distributed stream clustering service 30 may thus predict, in near real time, the IoA entity 90 that best relates to both the streaming data 34 and the micro-cluster(s) 48. A Classifier API 92, for example, classifies the node 28 and/or the endpoint client device 36 (illustrated in FIG. 1) to fetch leaf nodes, which are used as features in the stream clustering machine learning model 44 (e.g., the clusterer 46 and its clustering algorithm, as explained with reference to FIG. 2). In this approach, the Classifier API 92 acts as feature extraction for the entity 90. A predictor module 94 (such as a predictive protocol buffer) retrieves and ingests the leaf nodes and generates the clusteral prediction 20. A clustering processor 96 calls the stream clustering 42 as a service, determines the micro-cluster 48 that best characterizes the streaming data 34, and retrieves the corresponding cluster ID 98 for the given entity 90. Once the cluster ID 98 is determined, service records 100 are logged (such as database entries describing the streaming data 34, the micro-cluster 48, the cluster ID 98, and other searchable metadata).

The distributed stream clustering service 30 predicts the micro-cluster 48 associated with the streaming data 34. The distributed stream clustering service 30 thus trains the stream clustering machine learning model 44 (e.g., the clusterer 46 and its hyperparameters) in a streaming fashion. The distributed stream clustering service 30 updates the stream clustering machine learning model 44 during run-time. The distributed stream clustering service 30 thus groups the incoming streaming data 34 in near real-time at arrival. The model learning may thus be linear, processing data points one-by-one. Moreover, the distributed stream clustering service 30 may separate featurization operations from clustering operations. Featurization converts the raw streaming data 34 into useful features with numerical embedding. Clustering groups similar data points together. Keeping these operations/processes separate improves computer functioning. Increased flexibility allows for different featurization methods without changing the clustering algorithm. Increased efficiency optimizes each process (featurization/clustering) independently. Increased scalability allows easier distribution of workloads across different resources. Separation of the featurization and clustering operations also increases maintainability by allowing simpler updates or replacements of one component without affecting the other components. In short, separating featurization and clustering operations makes the overall service and system more modular and easier to manage. The clustering algorithm may be agnostic of the feature set or how they are derived, as long as they conform to the contract of namespace allocation.

The distributed stream clustering service 30 may also host and utilize different streaming cluster algorithms. Each streaming cluster algorithm, though, may be agnostic to the inputted streaming data 34. Whatever streaming cluster algorithms are installed, the streaming cluster algorithms assign proper labels to the predicted cluster ID 98. The distributed stream clustering service 30, though, may or may not have pre-trained models to hydrate from (such as the pre-trained, baseline stream clustering machine learning model 44, as explained with reference to FIGS. 1-6). The distributed stream clustering service 30 supports near-real time, online training, thus allowing adaptation and responsive results to novel entities 90 not seen in pre-trained models. The distributed stream clustering service 30 is scalable and accommodates distributed/nodal learning and merging thereafter (as explained with reference to FIG. 6). The distributed stream clustering service 30 may thus accept various streaming inputs (such as single dimension array, serialized n-dimensional array, or other pythonic form). The distributed stream clustering service 30 may then output the clusteral prediction 20 (such as the cluster ID 98 and additional metadata describing the type of input and method of clustering).

The clusteral prediction 20 identifies the entity 90. The distributed stream clustering service 30 receives the streaming data 34 as its input, determines the micro-cluster(s) 48 proximate to the data point, and generates the clusteral prediction 20 as an output. The distributed stream clustering service 30 thus predicts the micro-cluster 48, its corresponding cluster ID 98, and the corresponding entity 90. The clusteral entity 90 may thus be defined as the input to clustering. For immutability and consistency in generated clusters, clusteral entity 90 may be generated by the same data and using the same clustering algorithm. Therefore, the clustering API 92 needs to have some validation on input data to ensure it matches the configured type.

The distributed stream clustering service 30 learns from, and adapts, to changing input streaming data 34. In order to create a comprehensive and identifiable clustering system that can evolve over time while maintaining traceability and specificity to the input data and algorithm used, the clusterer lifecycle 60 is established. The distributed stream clustering service 30 creates the durable clusterer 46 (e.g., the stream clustering machine learning model 44) for the life of a given input type with a distinct set for hyper-parameters. The distributed stream clustering service 30, for example, creates a flexible, versioned clustering mechanism tailored to specific entity types (e.g., input vector) in the context of cybersecurity incidents of attacks and entities 90. For instance, if the input is a type of an anomalous process execution (or APEX) model's XGBoost leaf nodes of specific length, the generated/predicted cluster ID 98 from a given streaming algorithm can be considered to be immutable for the lifetime. Thus, the cluster ID 98 may represent, for example, the clustering algorithm (such as DBSTREAM), a namespace (such as Apex-model-v8-leaf-preds of length 25), a version (uniquely identifying the hyperparameters of the clusterer 46, as there may be potential iterations over time with improvements), and/or an alphanumeric identifier (such as the actual cluster ID 98 predicted by the clusterer 46). The namespace defines or identifies the clusterer 46 for a given cluster entity type. For instance, Apex-model-v8-leaf-preds, so that these become durable global clustering objects that clients can trust for consistency.

The distributed stream clustering service 30 thus implements online, distributed training and inference at run-time. The distributed stream clustering service 30, in particular, may identify and add new micro-clusters 48 during online learning. That is, after learning from a sufficient number of observations, newer micro-clusters 48 that are discovered can be turned into prediction. Hence, the distributed stream clustering service 30 incorporates training as a part of the streaming infrastructure. The count, population, and/or distribution of the micro-clusters 48 may grow or increase with time as the streaming data 34 changes. The distributed stream clustering service 30 may thus be configured to expand the number of micro-clusters 48 over time. The distributed stream clustering service 30 need not be restricted or limited to a fixed number/count/distribution of the micro-clusters 48. The distributed stream clustering service 30 durably records and maintains records of whatever micro-clusters 48 have been determined over time (such as cluster centroids). So, even though the distributed stream clustering service 30 learns and adapts to changing streaming data 34, the distributed stream clustering service 30 still retains records of historical micro-clusters 48. The historical micro-clusters 48 need not be purged/deleted from memory, thus allowing the distributed stream clustering service 30 grow and cluster a wide range of input streaming data 34.

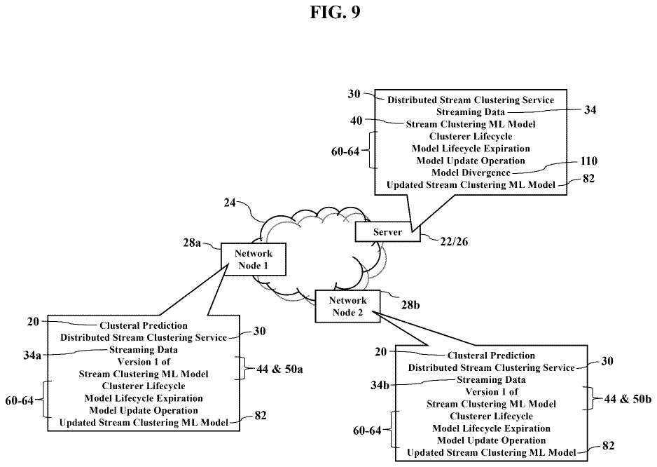

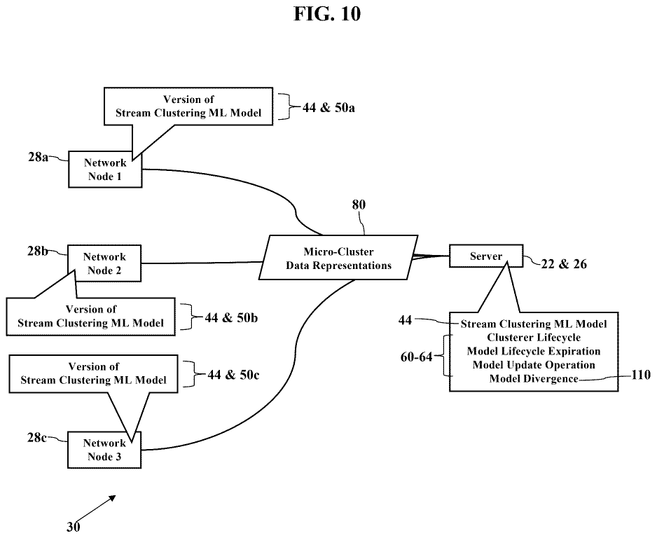

FIGS. 9-10 illustrate more examples of the clusterer lifecycle 60. The distributed stream clustering service 30 initially distributes the pre-trained/baseline stream clustering machine learning model 44 to the networked nodes 28. Each individual network node 28 then processes its streaming data 34 using the pre-trained stream clustering machine learning model 44 as a base learner and predictor. The pre-trained stream clustering machine learning model 44, though, may be associated with its corresponding clusterer lifecycle 60 and/or the model lifecycle expiration 62. Simply put, when the clusterer lifecycle 60 expires, the distributed stream clustering service 30 initiates and performs the clustering model update operation 64. Because the clusteral learning is scaled and distributed among the networked nodes 28, each node 28 independently and individually learns based on the streaming data 34 its assigned to process. As the networked nodes 28 are trained in near real time in the distributed setting, there will be drift among the nodal models. In perhaps a short time, in other words, the networked nodes 28 will develop the different versions 50 of the stream clustering machine learning model 44. At some point, then, the different versions 50 of the stream clustering machine learning model 44 diverge too great and trigger the clustering model update operation 64. The different versions 50 of the stream clustering machine learning model 44, in other words, equal, exceed, or otherwise satisfy a model divergence 110 specified by, and/or associated with, the clusterer lifecycle 60. When the distributed stream clustering service 30 determines that the model divergence 110 is satisfied or present, the distributed stream clustering service 30 may pause or suspend nodal/global processing/learning of the incoming streaming data 34. In response to the model divergence 110, the computer system 22 (again illustrated as the server 26) merges the different versions 50 to create the next version of the clusterer 46 (e.g., the updated stream clustering machine learning model 82). The distributed stream clustering service 30 distributes/pushes and installs the updated stream clustering machine learning model 82 to the networked nodes 28. The distributed stream clustering service 30 may then resume processing/learning of new streaming data 34 at the next cycle by using the updated stream clustering machine learning model 82 for prediction.

FIG. 10 illustrates a clusteral reporting scheme. As the networked node 28 processes its assigned streaming data 34, the networked node 28 stores and logs service details. The networked node 28, for example, generates the micro-cluster data representations 80 describing its localized micro-clusters 48. The cluster feature vector (or CFV), for example, may represent its corresponding micro-cluster 48. The networked node 28 may then report the micro-cluster data representations 80 back to the distributed stream clustering service 30. The networked node 28, for example, generates and sends the micro-cluster data representations 80 as a packetized message the network/IP address associated with the computer system 22 (again illustrated as the server 26).

The distributed stream clustering service 30 may then compare the micro-cluster data representations 80. The server 26, for example, collects the micro-cluster data representations 80 reported by the networked nodes 28 participating in the distributed stream clustering service 30. The server 26 may then analyze the micro-cluster data representations 80 to assess the model divergence 110 associated with the clusterer lifecycle 60. If the model divergence 110 indicates that one or more of the nodal versions 50 of the stream clustering machine learning model 44 has/have diverged too much, then the server 26 triggers the clustering model update operation 64.

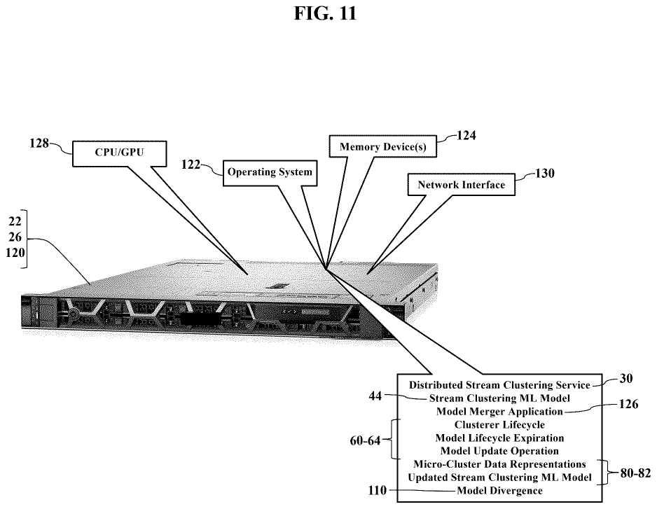

FIG. 11 illustrates more examples of the model divergence 110. FIG. 11 illustrates the computer system/server 22/26 as a rack server 120 that is commonly installed in server rooms and server farms. The rack server 120 is programmed to provide at least a portion of the distributed stream clustering service 30 (such as the clustering model update operation 64). The rack server 120 stores and executes an operating system 122 in a memory device 124. The rack server 120 also stores a model merger application 126 in the memory device 124. The rack server 120 has a hardware processor with cores 128 (illustrated as “CPU/GPU”) that reads and executes the operating system 122 and the model merger application 126. The rack server 120 also has network interfaces 130 to multiple communications networks (such as the cloud computing environment 24 illustrated in FIGS. 1-5), thus allowing bi-directional communications with the networked nodes 28 (illustrated in FIGS. 1-6) and other services. The model merger application 126 has programming code or instructions that cause the rack server 120 to perform operations, such as analyzing the micro-cluster data representations 80 and assessing the model divergence 110 associated with the different nodal versions 50 of the stream clustering machine learning model 44 (as previously explained with reference to FIGS. 3-6 & 9-10). When the model divergence 110 is determined, then the rack server 120 may suspend nodal processing and initiate the clustering model update operation 64. If one or more of the different nodal versions 50 of the stream clustering machine learning model 44 has/have diverged too much (such as when compared to the initial, pretrained base version), then the server 26 generates the updated stream clustering machine learning model 82. That is, the model merger application 126 uses the micro-cluster data representations 80 to determine the model divergence 110. If the current micro-cluster data representations 80 differ too much from those associated with the pre-trained/baseline stream clustering machine learning model 44, then the model merger application 126 may initiate the clustering model update operation 64.

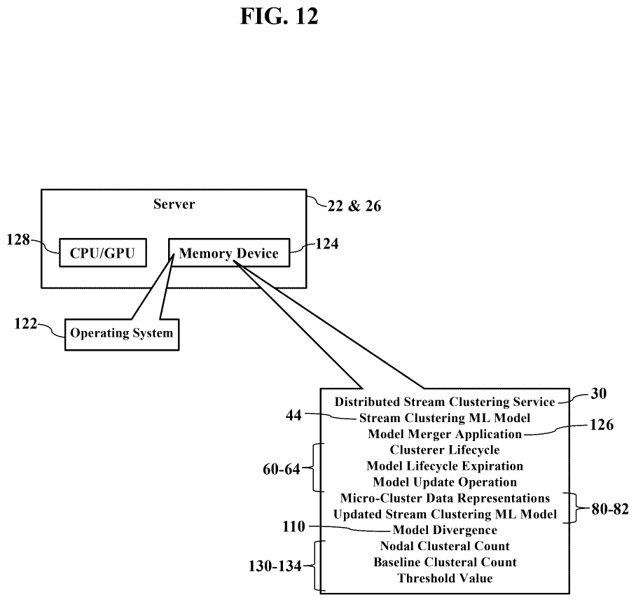

FIG. 12 illustrates examples of the model divergence 110 as a nodal clusteral count 130. When the computer system 22 (again illustrated as the server 26) receives the micro-cluster data representations 80, the model merger application 126 may instruct the hardware processor 128 to cooperate with the operating system 122 and to read the informational content specified/referenced/linked by the micro-cluster data representations 80. Each networked node 28 (illustrated in FIGS. 1-6 & 9-10), for example, may report its current nodal clusteral count 130 of the micro-clusters 48 generated by the corresponding networked node 28 (as explained with reference to FIGS. 1-10). The model merger application 126 may then instruct the hardware processor 128 to compare the current nodal clusteral count 130 to the baseline clusteral count 132 associated with the initially-installed, pretrained base version of the stream clustering machine learning model 44. The model divergence 110, for example, may be a simple mathematical difference or change between current values and base/initial values:

Model Divergence=C_{Current}−Cᵢ,

where C_{Current} is the current nodal clusteral count 130 associated with the current version 50 of the stream clustering machine learning model 44, and where Cᵢ is the baseline clusteral count 132 associated with the original, pre-trained version of the stream clustering machine learning model 44. Once the model divergence 110 is determined, the model merger application 126 may then instruct the hardware processor 128 to compare the model divergence 110 to a threshold value 134. The threshold value 134, for example, represents the maximum permissible count divergence between current values and base/initial values. If the model divergence 110, for example, is less than the threshold value 134, then the current nodal clusteral count 130 (C_{Current}) has not excessively grown or increased. An acceptable model divergence 110 indicates that the clustered streaming data 34 has not varied over tolerable limits. If, however, the model divergence 110 equals or exceeds the threshold value 134, then the node 28 has added too many new micro-clusters 48 since installation. The unacceptable model divergence 110 indicates that the streaming data 34 has grown in variability, so the clustering model update operation 64 is needed. The model merger application 126, for example, may instruct the hardware processor 128 to generate the updated stream clustering machine learning model 82 by merging the micro-cluster data representations 80 reported by the single networked node 28, some of the networked nodes 28, and/or by all the networked nodes 28.

A simple example helps explain the model divergence 110. Suppose the original, pre-trained version of the stream clustering machine learning model 44 initially establishes ten (10) micro-clusters 48. The networked node 28 installs the pre-trained stream clustering machine learning model 44 and begins processing the streaming data 34. After twenty four (24) hours of learning and clustering, though, the networked node 28 reports twenty (20) micro-clusters 48. In this simple example, the model divergence 110 is (20−10)=10, indicating ten extra micro-clusters 48 have been learned and added since model inception. If the threshold value 134 is 5, then too many extra micro-clusters 48 have been added, the streaming data 34 is too variable, and the clustering model update operation 64 is needed.

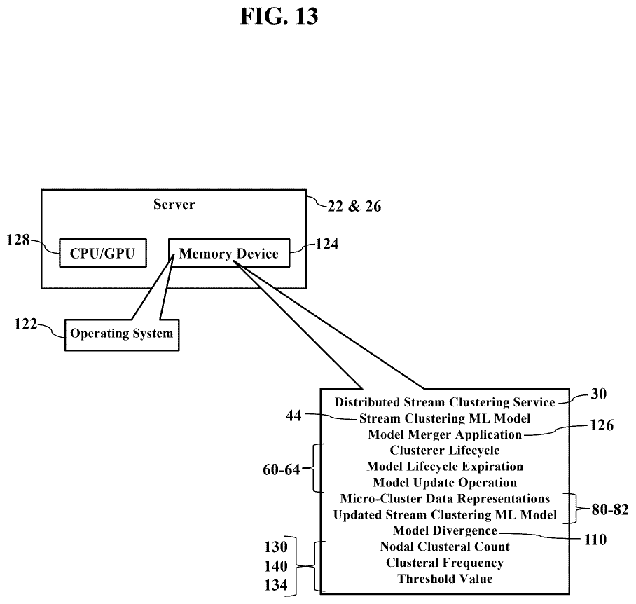

FIG. 13 illustrates examples of the model divergence 110 as a formational clusteral frequency 140. When the rack server 120 receives the micro-cluster data representations 80, the model divergence 110 may be based on the formational clusteral frequency 140 described by the micro-cluster data representations 80 (and associated with the nodal micro-clusters 48). As the network node 28 processes and clusters the streaming data 34, the stream clustering machine learning model 44 trains and evolves in response to variations in the streaming data 34 (as explained with reference to FIGS. 1-10). Each network node 28 may thus periodically report its current nodal clusteral count 130 of its micro-clusters 48. As the rack server 120 collects all these reported nodal clusteral counts 130, the model merger application 126 may cause the hardware processor 128 to determine a frequency or rate change with which new micro-clusters 48 are formed and added (based on the current nodal clusteral count(s) 130). The formational clusteral frequency 140, for example, may be determined on an individual nodal basis. The formational clusteral frequency 140, however, may be a global or service-wide determination based on the population reports of the nodes 28 providing the distributed stream clustering service 30. The model merger application 126 may then instruct the hardware processor 128 to compare the current formational clusteral frequency 140 to the corresponding nodal/global threshold value 134. Here, though, the threshold value 134, for example, represents the maximum permissible rate that any individual node 28, or the entire nodal service population, may generate and add new micro-clusters 48 (perhaps due to data variation). If the current formational clusteral frequency 140 is less than the nodal/global threshold value 134, then the rate of growth (if any) in the nodal/global clusteral count 130 (C_{Current}) is acceptable. An acceptable formational clusteral frequency 140 may again indicate that the clustered streaming data 34 has not varied over tolerable limits. If, however, the formational clusteral frequency 140 equals or exceeds the nodal/global threshold value 134, then too many micro-clusters 48 are being added and the model divergence 110 is confirmed. The excessive formational clusteral frequency 140 indicates that the streaming data 34 has grown in variability and the model divergence 110 is present, so the clustering model update operation 64 is needed. The model merger application 126 may thus instruct the hardware processor 128 to generate the updated stream clustering machine learning model 82 by merging the micro-cluster data representations 80 reported by one or more networked nodes 28.

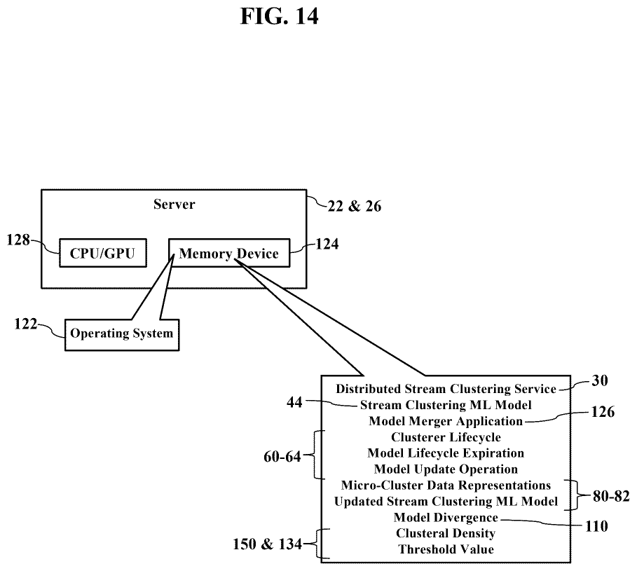

FIG. 14 illustrates examples of the model divergence 110 as a clusteral density 150.

When the rack server 120 receives the micro-cluster data representations 80, the model divergence 110 may be based on the clusteral density 150 associated with the micro-clusters 48. As the network node 28 processes and clusters the streaming data 34, each data point may be graphically 2D/3D mapped to its nearest centroidal micro-cluster 48. As more and more streaming data points are clustered, each micro-cluster 48 will have a corresponding membership, population count, distribution, centroid/radius, and many other statistical measures. The clusteral density 150 may thus be a clusteral descriptor that relates the population count to the 2D area, or 3D spherical volume, of the micro-cluster 48. So, as the stream clustering machine learning model 44 trains and evolves in response to variations in the streaming data 34, some micro-clusters 48 grow in population and/or area/volume, thus impacting their corresponding clusteral density 150. Other micro-clusters 48, though, may reduce their population and/or area/volume. Each network node 28 may thus report its current clusteral density/densities 150 associated with its micro-clusters 48. As the rack server 120 collects all these reported nodal clusteral densities 150, the model merger application 126 may instruct the hardware processor 128 to determine density change(s) as the micro-clusters 48 evolve over time.

Outlier clusteral densities 150 may trigger the clustering model update operation 64.

As the networked nodes 28 cluster the streaming data 34, the rack server 120 monitors the clusteral densities 150 on an individual nodal basis and/or on a global or service-wide basis. The model merger application 126, for example, may instruct the hardware processor 128 to compare one or more clusteral densities 150 to the corresponding nodal/global threshold value 134. If the current clusteral density 150 is less than the nodal/global threshold value 134, then perhaps the model merger application 126 initiates the clustering model update operation 64. If, however, the current clusteral density 150 equals or is greater than the nodal/global threshold value 134, then perhaps the model merger application 126 has discretion to perform the clustering model update operation 64. Suppose, for example, that the threshold value 134 represents the minimum permissible clusteral density 150 for any individual micro-cluster 48. If a micro-cluster 48 becomes too thinly populated, or too area/volume large/dispersed, then perhaps that micro-cluster 48 is a candidate for clusteral merger with a neighboring micro-cluster 48. Conversely, if a micro-cluster 48 becomes heavily/densely populated, or too small in area/volume, then perhaps that micro-cluster 48 is a candidate for clusteral split or division into new, separate micro-clusters 48. Simply put, the clusteral density 150 is yet another measure or indicator of variability, or stability/uniformity, of the streaming data 34. However the nodal/global threshold value 134 is defined, threshold satisfaction indicates that the model divergence 110 is present, so the clustering model update operation 64 is needed. The model merger application 126 may thus instruct the hardware processor 128 to generate the updated stream clustering machine learning model 82 by merging the micro-cluster data representations 80 reported by one or more networked nodes 28.

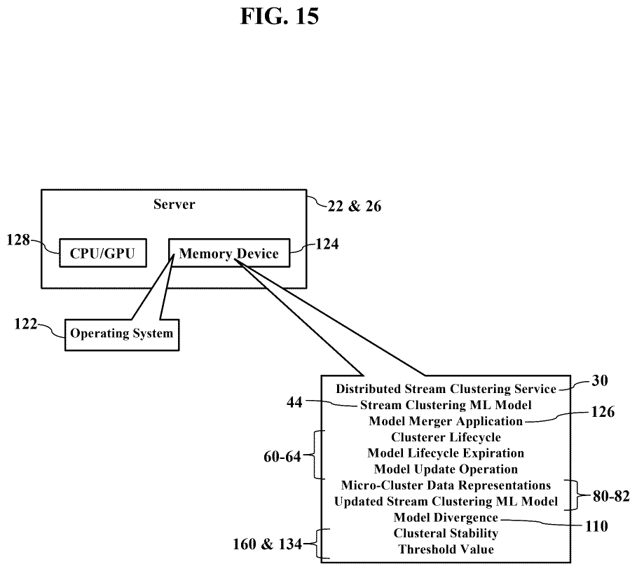

FIG. 15 illustrates examples of the model divergence 110 as a clusteral stability 160.

When the rack server 120 receives the micro-cluster data representations 80, the model divergence 110 may be based on the clusteral stability 160 associated with one or more of the micro-clusters 48. Grouping the streaming data points into the micro-clusters 48 is very complex. The clusteral stability 160 measures, indicates, or characterizes the strength and reproducibility of the micro-cluster 48 and its member data points. The data members of the micro-cluster 48 may thus be highly similar to each other (perhaps using similarity analysis). Recall that the networked node 28 installs the pre-trained/baseline/original stream clustering machine learning model 44 and begins clustering the streaming data 34 according to the baseline micro-clusters 48 (as explained with reference to FIGS. 1-10). However, as the networked node 28 processes more and more streaming data 34, the stream clustering machine learning model 44 learns and retrains according to changes/perturbations in the streaming data 34. The clusteral stability 160 thus assesses the performance and/or reproducibility of data clustering over time. If stream clustering is stable, then the micro-clusters 48 are preserved over time (e.g., the original/baseline micro-clusters 48 resemble, or are similar to, later micro-clusters 48). The underlying micro-cluster data representations 80, in other words, are preserved in the perturbed data clustering. However the clusteral stability 160 is defined, the rack server 120 may monitor the clusteral stability 160 on an individual nodal basis and/or on a global or service-wide basis. The model merger application 126, for example, may instruct the hardware processor 128 to compare one or more clusteral stabilities 160 to a corresponding nodal/global threshold value 134. If the current clusteral stability 160, for example, equals or exceeds the nodal/global threshold value 134, then perhaps the model merger application 126 has discretion to perform the clustering model update operation 64. If, however, the current clusteral stability 160 is less than the nodal/global threshold value 134, then the model divergence 110 is determined and perhaps the model merger application 126 initiates the clustering model update operation 64. The model merger application 126 may thus instruct the hardware processor 128 to generate the updated stream clustering machine learning model 82 by merging the micro-cluster data representations 80 reported by one or more networked nodes 28.

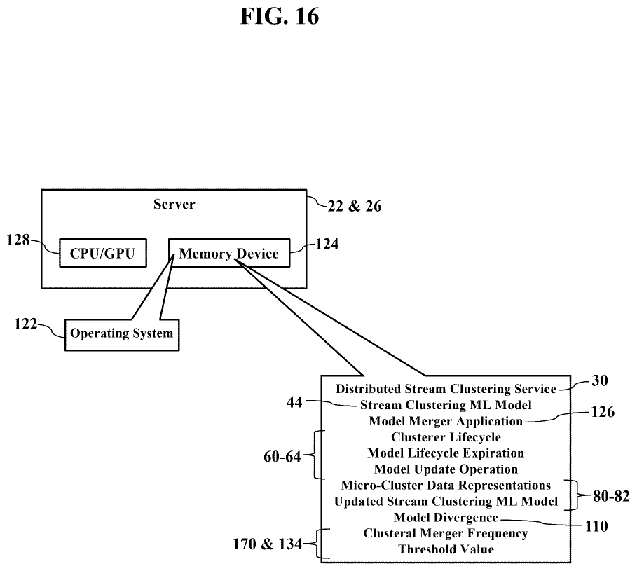

FIG. 16 illustrates examples of the model divergence 110 as a clusteral merger frequency 170. When the rack server 120 receives the micro-cluster data representations 80, the model divergence 110 may be based on the clusteral merger frequency 170 associated with one or more of the micro-clusters 48. As the networked nodes 28 cluster the streaming data 34, two or more micro-clusters 48 may be merged together or combined for statistical, performance, and/or other criteria. Some micro-clusters 48, for example, may have statistically similar and/or graphically proximate data points and/or centroids and merged together. The model merger application 126 may thus cause the hardware processor 128 to monitor the clusteral merger frequencies 170 reported by the networked nodes 28. The clusteral merger frequencies 170 may also be compared to a corresponding nodal/global threshold value 134. Here, though, the nodal/global threshold value 134, for example, may represent a minimum or maximum permissible frequency or rate of clusteral mergers by a single node 28 and/or by the entire nodal population. If the current clusteral merger frequency 170, for example, is less than the nodal/global threshold value 134, then perhaps the model merger application 126 has discretion to perform the clustering model update operation 64. If, however, the current clusteral merger frequency 170 equals or exceeds the nodal/global threshold value 134, then the model divergence 110 is determined and perhaps the model merger application 126 initiates the clustering model update operation 64. The model merger application 126 may thus instruct the hardware processor 128 to generate the updated stream clustering machine learning model 82 by merging the micro-cluster data representations 80 reported by one or more networked nodes 28.

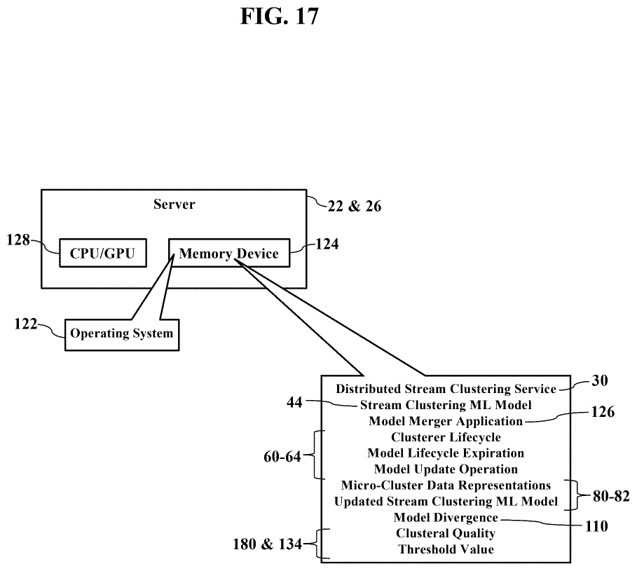

FIG. 17 illustrates examples of the model divergence 110 as a clusteral quality 180. When the rack server 120 receives the micro-cluster data representations 80, the model divergence 110 may be based on the clusteral quality 180 associated with one or more of the micro-clusters 48. The clusteral quality 180 may be score or other measure of how well the networked node(s) 28 clustered the streaming data 34. The clusteral quality 180, for example, may be defined or determined using similarity analysis. The best quality micro-cluster 48, for example, has high similarity among its internal data members, but the micro-cluster 48 also has a low similarity to other, external micro-clusters 48. Moreover, the clusteral quality 180 may be dependent on the clustering algorithm (e.g., the clusterer 46 and its hyperparameters). Because the distributed stream clustering service 30 may have access to different clustering algorithms (as explained and illustrated with reference to FIGS. 7-8), the clusteral quality 180 may also be influenced by the nodal clustering scheme. Indeed, because there are many different internal and external schemes for clusteral quality 180, the clusteral quality 180 may have a subjective component (such as human assessment). The distributed stream clustering service 30, for example, may use the Davies-Bouldin index, the Dunn index, the silhouette coefficient, purity, the Rand index, F-measures, and/or the Jaccard index as indicators of the clusteral quality 180. There are many other internal/external schemes for determining the clusteral quality 180, and the model merger application 126 may implement whatever scheme(s) is/are desired to measure or evaluate the clusteral quality 180.

The rack server 120 assesses the clusteral quality 180. As the rack server 120 collects or retrieves the micro-cluster data representations 80, the model merger application 126 may use the micro-cluster data representations 80 to determine one or more values of the clusteral quality 180. The rack server 120 may thus monitor the clusteral quality/qualities 180 reported by the networked nodes 28 and compare to a corresponding nodal/global threshold value 134. If the current clusteral quality 180, for example, equals or exceeds the nodal/global threshold value 134, then perhaps the clusteral quality 180 is sufficient/acceptable and the model merger application 126 has discretion to decline or to perform the clustering model update operation 64. If, however, the current clusteral quality 180 is less than the nodal/global threshold value 134, then the model divergence 110 is determined and perhaps the model merger application 126 initiates the clustering model update operation 64. The model merger application 126 may thus instruct the hardware processor 128 to generate the updated stream clustering machine learning model 82 by merging the micro-cluster data representations 80 reported by one or more networked nodes 28.

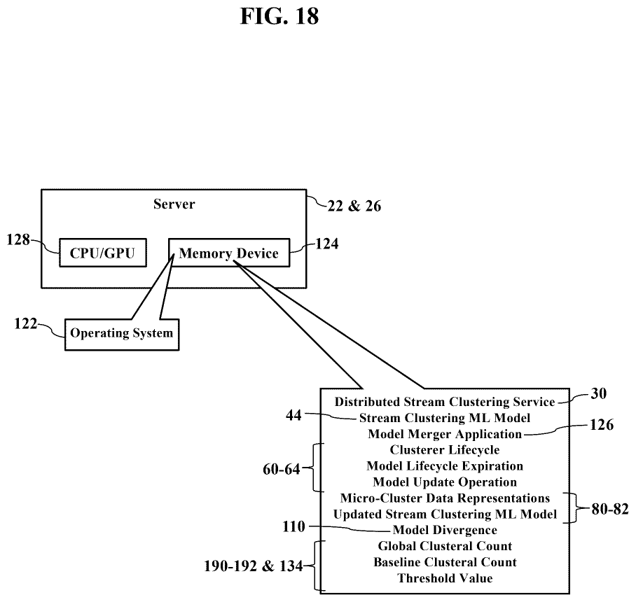

FIG. 18 illustrates examples of the model divergence 110 as a global or total clusteral count 190 of the micro-clusters 48. When the rack server 120 receives the micro-cluster data representations 80 reported by the networked nodes 28, the model merger application 126 may instruct the hardware processor 128 to determine the current global or total clusteral count 190 of the micro-clusters 48 associated with the distributed stream clustering service 30. The rack server 120, for example, may sum or tally all the micro-clusters 48 reported by each networked node 28. The rack server 120 may then compare the global or total clusteral count 190 to an original, baseline global count 192 established by the initially-installed, pretrained base version of the stream clustering machine learning model 44. The model divergence 110 may then be a simple mathematical difference or change between current values and base/initial values (e.g., Model Divergence=C_{Current}−Cᵢ). Once the model divergence 110 is determined, the model merger application 126 may then instruct the hardware processor 128 to compare the model divergence 110 to its corresponding threshold value 134. Here, though, the threshold value 134 may represent the maximum permissible difference or change between the current count 190 and the initial/baseline count 192. If the count difference/change is less than the threshold value 134, then the current global or total clusteral count 190 (C_{Current}) has not excessively grown or increased. If, however, the count difference/change equals or exceeds the threshold value 134, then too many micro-clusters 48 have been newly added since model installation. The unacceptable model divergence 110 may thus indicate that the streaming data 34 has grown in variability (thus requiring new micro-clusters 48), so the clustering model update operation 64 is needed. The model merger application 126, for example, may instruct the hardware processor 128 to generate the updated stream clustering machine learning model 82 by merging the micro-cluster data representations 80 reported by the networked nodes 28.

The model divergence 110 further improves computer functioning. The model divergence 110 ensures that the machine intelligence (e.g., computer hardware and software resources) remains relevant with the streaming data 34. The model divergence 110 further enforces a durability factor as a by-product of the architecture of the solution; in other words, the historical micro-clusters 48 that are formed way back in time are still retained, even if newer data points are not radially proximate to historical data.

The model divergence 110 also promotes clusteral merger and division. Clustering experience has shown that newer streaming data points may exteriorily scattered around previously formed micro-clusters 48, even falling under the threshold parameters 134 associated with the clustering model update operation 64. In centroid-based clustering, for example, the centroid may shift ever so slightly, depending on a weighted average of its original weight and new cluster weight. The distributed stream clustering service 30 may thus create new micro-clusters 48 (e.g., when distance of newly formed micro-cluster 48 is outside a merge distance from existing micro-cluster) or merge with existing micro-clusters 48 (e.g., when distance is within merge distance threshold). The degree to which a cluster center/centroid would shift depends on the relative density of each micro-cluster 48.

The model divergence 110 may utilize whatever model performance metrics that suit cost, quality, and/or performance objectives. In centroidal-based clustering, for example, the distributed stream clustering service 30 may use radial/Euclidean distances between a streaming input data point and its nearest-neighbor micro-cluster 48 may be used. The smaller the distance, the greater the accuracy. For non-centroidal-based clustering, for example, silhouette clustering techniques may be used.

The distributed stream clustering service 30 may also implement feature importance. There are many different schemes for determining feature importance, and the distributed stream clustering service 30 may again utilize whatever online/offline feature importance solution that suit cost, quality, and/or performance objectives. Subject matter experts, for example, may evaluate different embedding schemes that convert the streaming data 34 into vector embeddings. Optimization techniques may be used to find the best set of embedding, hyperparameters, and algorithms. Data Scientists, for example, may conduct controlled experiments with labelled data to measure accuracy and performance for a range of hyperparameters and pick the best featurizer, while perhaps also making incremental improvements through its lifecycle.

The distributed stream clustering service 30 is thus an elegant solution. The distributed stream clustering service 30 distributes real-time learning and inferencing/prediction for data stream clustering. The distributed stream clustering service 30 combines distributed learning and prediction in a single service, eliminating the need for offline learning and deployment. The distributed stream clustering service 30 distributes the learning process across the multiple networked nodes 28, with each node 28 independently processing a portion of the incoming streaming data 34 in near real-time. The pre-trained clusterer model (e.g., the stream clustering machine learning model 44) is distributed across the multiple nodes 28. As new data streams in, each node 28 independently updates its local/nodal clustering model. To address the potential drift among these distributed models, the distributed stream clustering service 30 implements a modal merging strategy triggered by the volume of data, by the passage of time, and/or by the model divergence 110 (as explained with reference to FIGS. 1-18). The distributed stream clustering service 30 thus ensures that the clustering model 40/82 is updated regularly to maintain its relevance and accuracy. During the merging process, the distributed stream clustering service 30 combines the independently-trained, versional nodal models 50 to create the updated version of the clusterer model (e.g., the updated stream clustering machine learning model 82). This merged model then becomes the new base model for prediction in the next cycle, ensuring that the distributed stream clustering service 30 continuously evolves and adapts to new patterns in the data stream.

The distributed stream clustering service 30 thus creates a durable clusterer model for the life of a given input type with a distinct set of hyperparameters. The optimal hyperparameters are determined through offline experiments prior to deployment. Once the optimal hyperparameters are finalized, they are used in the distributed training and inference for the stream clusterer. This approach ensures that the stream clustering machine learning model 44 remains relevant and effective over time, even as the underlying data patterns change.

The distributed stream clustering service 30 strategically compensates for drift. To handle the potential issue of concept drift, where the underlying distribution of the data changes over time, the clusterer 46 adheres to its original definition. That is, within the lifecycle of a clusterer version (i.e., for a given set of hyperparameters), the clusterer adheres to its original definition. During merging cycles, cluster identities of its base clusterer are preserved. Merging only adds new micro-clusters 48 and does not remove any previously predicted micro-clusters 48. During distributed training cycles, micro-cluster centers/centroids may change, but only within a specified threshold. This ensures that there is no significant drift between previously predicted micro-clusters 48 and the same micro-clusters 48 in future iterations. If significant changes are observed in data distribution (such as via determining the model divergence 110), offline experiments may be conducted again to re-optimize hyperparameters, resulting in a newer version of the clusterer 46.

The distributed stream clustering service 30 further compensates. The distributed stream clustering service 30 determines when significant changes in data distribution have occurred via the model divergence 110. If the rate of new cluster creation significantly increases, the model divergence 110 may indicate a shift in the underlying data distribution. Substantial changes in the clusteral density 150 of existing micro-clusters 48 over time could signal a shift in data patterns. If existing micro-clusters 48 become increasingly unstable or start to merge frequently, the model divergence 110 may indicate changing data distributions. A decline in the clusteral quality 180 (e.g., silhouette score, Davies-Bouldin index) may trigger a re-evaluation. Moreover, changes in the relative importance of features used for clustering might suggest a shift in the underlying data structure. When these indicators exceed their corresponding threshold values 134, the distributed stream clustering service 30 flags the need for hyperparameter re-optimization and the creation of a new clusterer version. These approaches thus adapt to gradual changes in data distribution while maintaining consistency in cluster identification. These approaches also provide a mechanism for major updates when the data distribution changes significantly.

The cluster lifecycle 60 is logged. The distributed stream clustering service 30 records service records and documents changes (such as the service log database 100 illustrated in FIG. 7). Clusterer records maintain traceability and specificity to the input data and the clustering algorithm used. This ensures that the evolution of the clusterer 46 over time is tracked and understood, providing valuable insights into the changing patterns in the data stream. For example, in a real-time, AIPowered, cybersecurity IOA clustering system, the distributed stream clustering service 30 continuously learns from incoming telemetry data across multiple nodes 28. Each node 28 would update its local clustering model based on the transactions it processes. When either a specified number of transactions have been processed or a set time has elapsed, these models would be merged to create an updated global model that reflects the latest and newest patterns across all nodes 28.

The distributed stream clustering service 30 adapts to the streaming data 34. The distributed stream clustering service 30 performs real-time incorporation of newly discovered micro-clusters clusters into the prediction model while preserving existing cluster identities. The lifecycle management policy for clusterer models maintains traceability and specificity to input data and algorithms. The distributed stream clustering service 30 creates durable clusterer models for specific input types and hyperparameter sets, allowing for long-term evolution and adaptation. The distributed stream clustering service 30 controls micro-cluster center adjustments within specified thresholds to prevent significant drift. The distributed stream clustering service 30 implements major model updates through offline hyperparameter re-optimization when significant data distribution changes are detected (such as via the model divergence 110).

The distributed stream clustering service 30 also balances new and old data. The distributed stream clustering service 30 preserves existing cluster identities 98 but, also, adapts to new patterns in the data stream. The distributed stream clustering service 30, for example, logs and retains the micro-cluster data representations 80 that were historically reported during previous cycles (such as via the service log database 100 illustrated in FIG. 7). The distributed stream clustering service 30, however, also identifies, logs, and stores new micro-cluster data representations 80 representing new micro-clusters 48 based on features of the input vector and clustering threshold. The distributed stream clustering service 30 ensures consistency and coherence across different nodes 28 during the distributed learning process by the globally synchronized model update operation 64, which may ensure that only one node 28 (such as the rack server 120) performs this activity and other nodes 28 would use the final clusterer model that is produced as a result of merging.

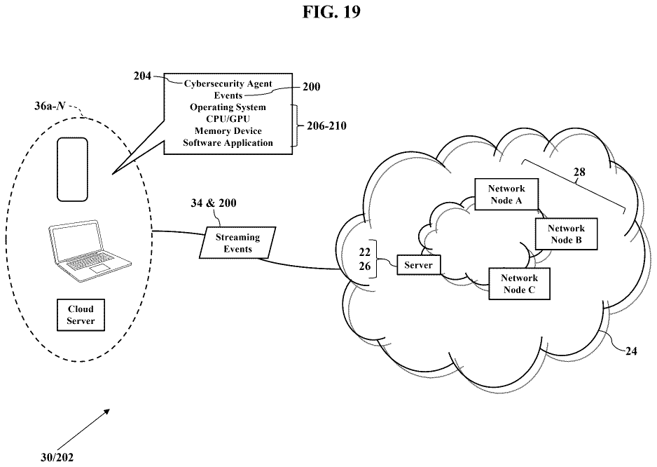

FIGS. 19-21 illustrate examples of cybersecurity event monitoring. Here the distributed stream clustering service 30 may analyze and cluster operating system events 200 reported by the client devices 36. The distributed stream clustering service 30 may thus be a component or subservice of a cybersecurity service 202 provided to customers and users. The cloud computing environment 24, in other words, may service and protect thousands or even millions of client devices 36 operating in the field. Such a large population of the client devices 36 is too difficult to illustrate, so FIG. 19 again merely illustrates another simple example. Each client device 36a-N subscribes to the digital services 30/202 and downloads, stores, and executes an endpoint cybersecurity agent 204. The endpoint cybersecurity agent 204, in other words, is installed on the corresponding client device 36. The endpoint cybersecurity agent 204 includes computer program, code, or instructions that scan and monitor its corresponding client device 36 for the operating system event(s) 200 associated with its host operating system 206. Each client device 36 has a host processor (“CPU/GPU”) 208 that executes its hosting operating system 206 stored in a memory device 210. Each client device 36 also locally stores and executes the endpoint cybersecurity agent 204. The endpoint cybersecurity agent 204, for example, interfaces with its host operating system 206 to establish event notifications of hardware and software events 34 (such as communications, processes, activities, behaviors, data values, usernames/logins, locations, contexts, and/or patterns that indicate computer activity). As the client device 36 executes the SAFARI® web browser, MICROSOFT WORD®, NETFLIX®, FACEBOOK®, or other software applications 212, thousands/millions/billions of the events 200 are requested. The host operating system 206 alerts the endpoint cybersecurity agent 204 of each event 200 (via the event notification) and awaits instructions. That is, the host operating system 206 holds/postpones the event(s) 200, thus allowing the the endpoint cybersecurity agent 204 time for event assessment. The endpoint cybersecurity agent 204 may thus stream the event(s) 200 (e.g., the streaming data 34) for analysis by the cloud computing environment 24. The endpoint cybersecurity agent 204 may also instruct the host operating system 206 to defer execution of the event(s) 200 and, instead, await a service response.

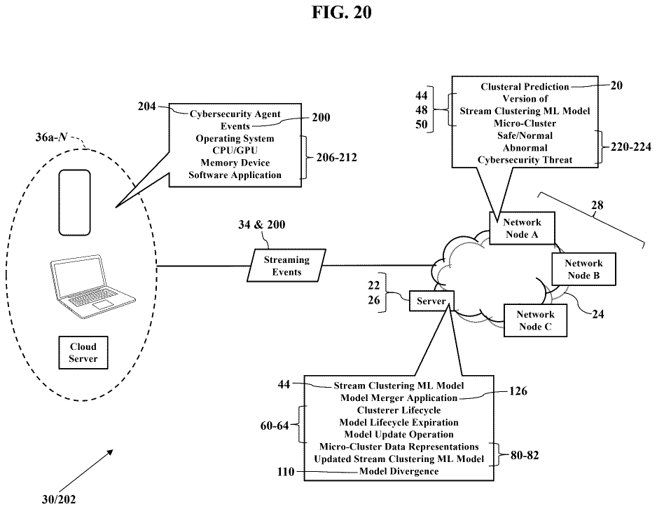

FIG. 20 illustrates event assessment. When the cloud computing environment 24 receives the event(s) 200, the cloud computing environment 24 assesses and clusters the event(s) 200 (as explained and illustrated with reference to FIGS. 1-18). Again, for simplicity, the networked members 28 process and cluster the event(s) 200 into the micro-clusters 48. The networked members 28, though, may also track and report their nodal micro-cluster data representations 80. The computer system/server 22/26 determines the model divergence 110 by assessing the micro-cluster data representations 80 (as explained and illustrated with reference to FIGS. 1-18). When the model divergence 110 is determined, the cloud computing environment 24 and/or the computer system/server 22/26 instructs the networked nodes 28 to temporarily halt/suspend processing of the streaming event(s) 200. The computer system/server 22/26 generates the updated stream clustering machine learning model 82 by merging the micro-cluster data representations 80. The cloud computing environment 24 and/or the computer system/server 22/26 instructs each networked node 28 to retrieve/download/install the updated stream clustering machine learning model 82. The cloud computing environment 24 and/or the computer system/server 22/26 may then instruct the networked nodes 28 to resume processing of the streaming event(s) 200 using the updated stream clustering machine learning model 82. The services 30/202 generate the clusteral prediction 20 (as explained and illustrated with reference to FIGS. 1-18). The clusteral prediction 20, in plain words, identifies the micro-cluster 48 that best characterizes or represents the event(s) 200. Moreover, the micro-cluster 48 also identifies the event(s) 200 as normal/safe computer operation 220 or as abnormal computer operation 222. If the client device's requested event(s) 200 conform to historical event norms, then the services 30/202 may predict that the client device 36 is behaving as historically observed and represents the normal/safe operation 220. If, however, the client device's requested event(s) 200 do not conform to historical event transitional norms, then the services 30/202 may predict that the client device 36 is abnormally behaving. The services 30/202 may thus generate the clusteral prediction 20 of the unsafe/abnormal operation 222. The services 30/202 may flag the event(s) 200 as a potential cybersecurity threat 224.

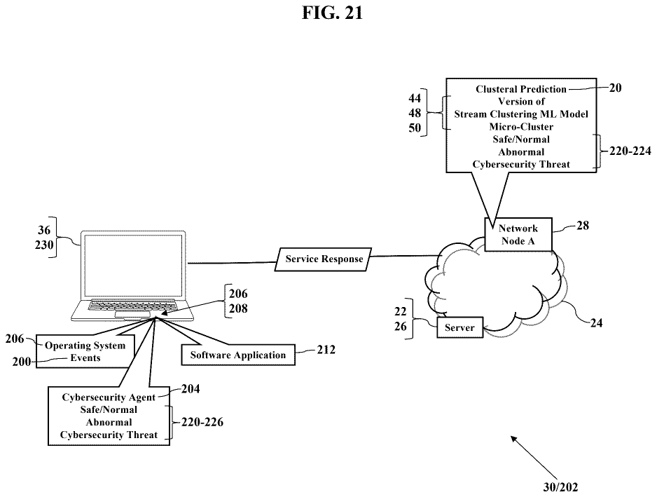

FIG. 21 illustrates examples of a service response. Once the clusteral prediction 20 is generated, the cloud computing environment 24 may alert the client device 36 (illustrated as a laptop computer 230). The services 30/202, for example, may instruct the network node 28 to send the service response back to the client device 36. The service response, though, may indicate or specify the clusteral prediction 20 (such as the normal/safe operation 220 or the unsafe/abnormal operation 222). When the laptop computer 230 receives the service response, the client's/host's operating system 206 may forward the service response to the endpoint cybersecurity agent 204. The endpoint cybersecurity agent 204 reads the service response and reacts to the predicted operation 220/222. If, for example, the normal/safe operation 222 is predicted, then the endpoint cybersecurity agent 204 instructs the operating system 206 to proceed with executing the event(s) 200. If, however, the unsafe/abnormal operation 224 is predicted, then the endpoint cybersecurity agent 204 may protect the laptop computer 32 from the potential cybersecurity threat 226. The endpoint cybersecurity agent 204, for example, may instruct the host operating system 206 to deny the event(s) 200. The operating system 206, in other words, may be commanded to not execute the requested event(s) 200. The endpoint cybersecurity agent 204 may even implement more protective measures, such as instructing the operating system 206 to terminate the software application 212 requesting the event(s) 200. The endpoint cybersecurity agent 204, in plain words, stops the event(s) 200 representing the cybersecurity threat 36.

As FIGS. 19-21 illustrate, the services 30/202 keep the model 44/50 relevant in view of the events 200. As the nodes 28 receive, process, and cluster the events 200, the nodes 28 also report their micro-cluster data representations 80 representing their nodal micro-clusters 48. The services 30/202 monitor and assess the micro-cluster data representations 80. When the model divergence 110 is determined (such as by the server 26), the cloud computing environment 24 (again, such as the server 26) suspends the stream clustering, merges the micro-cluster data representations 80, and generates the updated stream clustering machine learning model 82. The cloud computing environment 24 (again, such as the server 26) instructs the nodes 28 to install the updated stream clustering machine learning model 82. So, after the nodes 28 confirm installation, stream clustering may resume using the updated stream clustering machine learning model 82. The nodes 28 thus parallel process and cluster the operating system events 200 using the updated stream clustering machine learning model 82.

The clusterer lifecycle 60 may be based on the operating system events 200. The clusterer lifecycle 60 ensures that the stream clustering machine learning model 44 is regularly updated (as explained and illustrated with reference to FIGS. 4-5). The clusterer lifecycle 60, for example, may be determined based on a local and/or global count of the events 200. The distributed stream clustering service 30, as another example, may increment the global counter 68 (as explained and illustrated with reference to FIG. 4) in response to each operating system event 200 processed/clustered by a single node 28, by a group or computing cluster of the nodes 28, and/or by all the nodes 28 affiliated with the distributed stream clustering service 30. The distributed stream clustering service 30 may initialize the global counter 68 at its initial value (such as zero) and, as each event 200 is processed/clustered, the distributed stream clustering service 30 increments the global counter 68 to its final value. When the global counter 68 reaches its final value, the clusterer lifecycle 60 expires and the clustering model update operation 64 may be triggered.

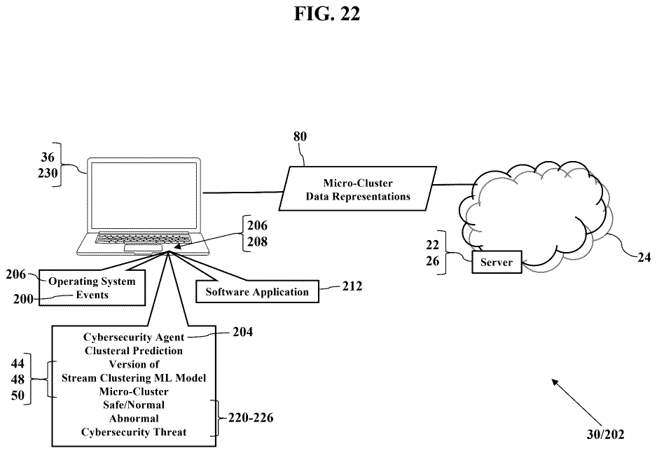

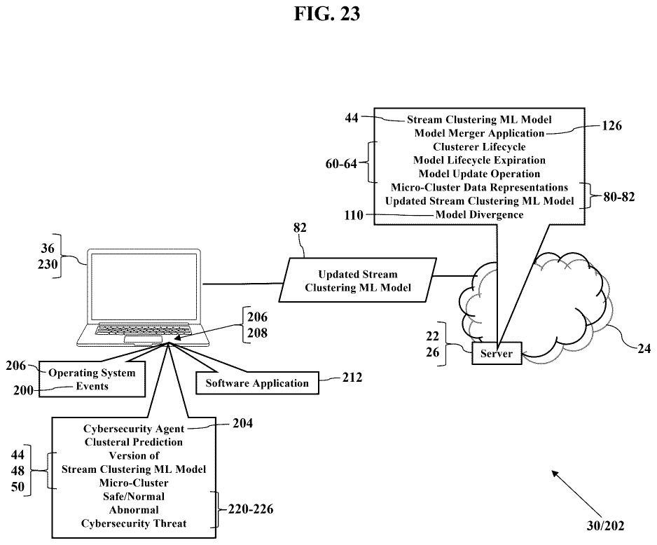

FIGS. 22-23 illustrate examples of localized cybersecurity event monitoring. Here the endpoint cybersecurity agent 204 locally assesses and clusters the event(s) 200. The endpoint cybersecurity agent 204 again interfaces with its host operating system 206 and registers for event notifications of the hardware and software events 34 (such as communications, processes, activities, behaviors, data values, usernames/logins, locations, contexts, and/or patterns that indicate computer activity). As the client device 36 executes SAFARI®, WORD®, NETFLIX®, FACEBOOK®, or other software applications 212, the host operating system 206 notifies the endpoint cybersecurity agent 204 of each event 200 (via the event notification) and awaits instructions.

The endpoint cybersecurity agent 204 assesses the events 200. The endpoint cybersecurity agent 204 cooperates with its host operating system 206 to download, store, and execute the stream clustering machine learning model 44. The endpoint cybersecurity agent 204 may thus process the events 200 and cluster the events 200 (as explained with reference to FIGS. 1-21). The endpoint cybersecurity agent 204, for example, identifies the micro-cluster 48 that best characterizes or represents the event(s) 200. Moreover, once the micro-cluster 48 is determined, the endpoint cybersecurity agent 204 may also predict the normal/safe computer operation 220 or the abnormal computer operation 222, perhaps based on the micro-cluster 48. Again, if the client device's requested event(s) 200 conform to historical event norms, then the endpoint cybersecurity agent 204 may predict that the client device 36 is behaving as historically observed and represents the normal/safe operation 220. If, however, the client device's requested event(s) 200 do not conform to historical event transitional norms, then the endpoint cybersecurity agent 204 may predict that the client device 36 is abnormally behaving. If the clusteral prediction 20 indicates the normal/safe computer operation 220, then the endpoint cybersecurity agent 204 may instructs the operating system 206 to proceed with executing the event(s) 200. If, however, the unsafe/abnormal operation 224 is predicted, then the endpoint cybersecurity agent 204 may instruct the host operating system 206 to deny the event(s) 200 to protect the laptop computer 32 from the potential cybersecurity threat 226. The endpoint cybersecurity agent 204 may even implement more protective measures, such as instructing the operating system 206 to terminate the software application 212 requesting the event(s) 200.

The endpoint cybersecurity agent 204 may also update the cloud computing environment 24. As the endpoint cybersecurity agent 204 processes and clusters the events 200, the endpoint cybersecurity agent 204 may also monitor and report its nodal micro-cluster data representations 80. The endpoint cybersecurity agent 204, for example, cooperates with its host operating system 206 to send/upload the nodal micro-cluster data representations 80 (perhaps via the network interface 130 illustrated in FIG. 11) to the network/IP address associated with the distributed stream clustering service 30 and/or the cybersecurity service 202. The endpoint cybersecurity agent 204 thus keeps the services 30/202 apprised of its historical and new/current/merged micro-clusters 48.

The endpoint cybersecurity agent 204 may be an antimalware driver. The endpoint cybersecurity agent 204, for example, may have kernel-level components having kernel-level permissions to a kernel of the operating system 206. The endpoint cybersecurity agent 204 may additionally have user-mode components having user-level permissions to a user mode of the operating system 206. The endpoint cybersecurity agent 204 may include computer program, code, or instructions that scan and monitor its host for the events 200, communications, processes, activities, behaviors, data values, usernames/logins, locations, contexts, and/or patterns that indicate evidence of a cybersecurity attack. Because the endpoint cybersecurity agent 204 has kernel-level permissions, the endpoint cybersecurity agent 204 may monitor any kernel-level activity and/or any user-mode activity conducted by its host. The endpoint cybersecurity agent 204 may register for and receive kernel-level notifications and call backs from the kernel.

FIG. 23 illustrates model merging. When the cloud computing environment 24 receives the micro-cluster data representations 80, the micro-cluster data representations 80 may be routed to the computer system/server 22/26 for analysis. The computer system/server 22/26 determines the model divergence 110 by assessing the micro-cluster data representations 80 (as explained and illustrated with reference to FIGS. 1-18). When the model divergence 110 is determined, the cloud computing environment 24 and/or the computer system/server 22/26 instructs the endpoint cybersecurity agent 204 to temporarily halt/suspend processing of the streaming event(s) 200. The computer system/server 22/26 generates the updated stream clustering machine learning model 82 by merging the micro-cluster data representations 80. The cloud computing environment 24 and/or the computer system/server 22/26 instructs the endpoint cybersecurity agent 204 to retrieve/download/install the updated stream clustering machine learning model 82. The cloud computing environment 24 and/or the computer system/server 22/26 may then instruct the endpoint cybersecurity agent 204 to resume processing of the streaming event(s) 200 using the updated stream clustering machine learning model 82. The endpoint cybersecurity agent 204 may then resume the clusteral/operational prediction 20/220/222.

The cybersecurity detection agent 204 further improves computer functioning. The cybersecurity detection agent 204 detects event evidence of the cybersecurity threat 226. Because the cybersecurity detection agent 204 detects the cybersecurity threat 226, the cybersecurity detection agent 204 may immediately shut down or terminate the malicious software application 212. The cybersecurity detection agent 204, for example, may prevent the cybersecurity threat 226 from accessing the memory device 208 (e.g., RAM, ROM, disk). The cybersecurity detection agent 204 may also instruct the operating system 206 to halt or terminate any current event/computer behavior that is queued for execution by the operating system 206 and/or by any of the software applications 212. The cybersecurity detection agent 204 may thus reactively or proactively stop the cybersecurity threat 226.

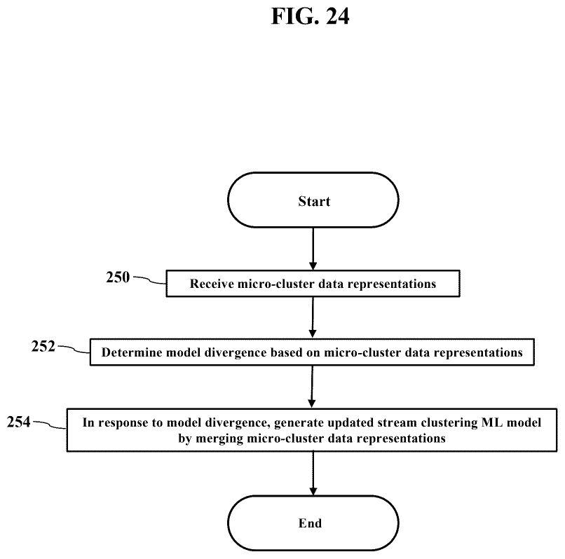

FIG. 24 illustrates examples of methods or operations executed by the computer system 22 that cluster the streaming data 34. The micro-cluster data representations 80 are received (Block 250) and the model divergence 110 is determined based on the micro-cluster data representations 80 (Block 252). In response to the model divergence 110, the updated stream clustering machine learning model 82 is generated by merging the micro-cluster data representations 80 (Block 254).

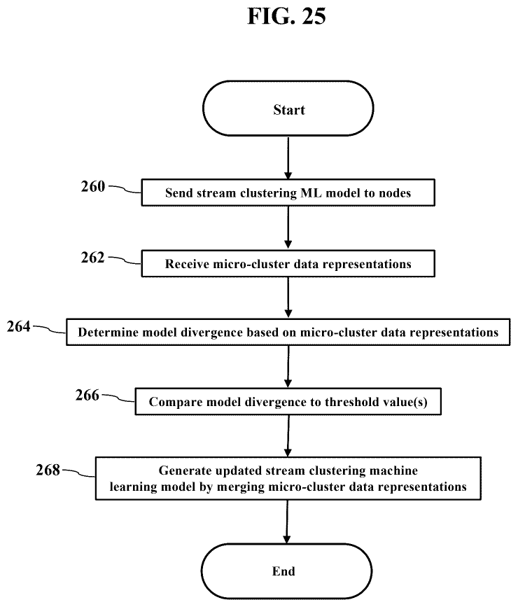

FIG. 25 illustrates more examples of methods or operations executed by the computer system 22 that cluster the streaming data 34. The stream clustering machine learning model 44 is sent to the computer nodes 28 associated with the distributed stream clustering service 30 (Block 260). The micro-cluster data representations 80 are received (Block 262) that were generated by the nodes 28 parallel processing the streaming data 34 by executing the stream clustering machine learning model 44. The model divergence 110 is determined based on the micro-cluster data representations 80 (Block 264). The model divergence 110 is compared to the threshold value 134 (Block 266). In response to the model divergence 110 satisfying the threshold value 134, the updated stream clustering machine learning model 82 is generated by merging the micro-cluster data representations 80 (Block 268).

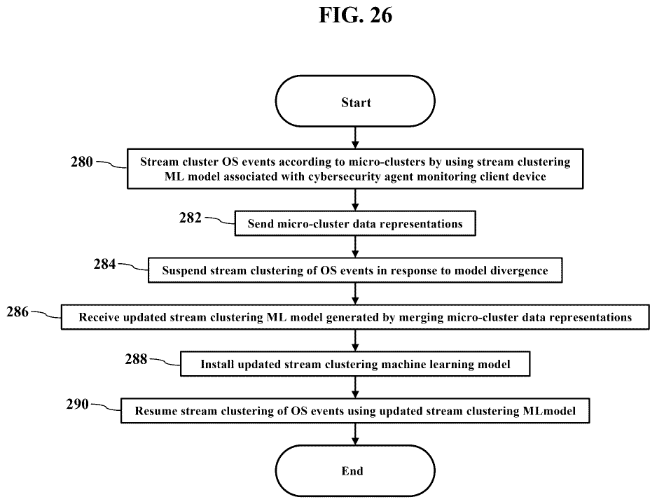

FIG. 26 illustrates still more examples of methods or operations executed by the computer system 22 that cluster the streaming data 34. The operating system events 200 are stream clustered according to the micro-clusters 84 by using the stream clustering machine learning model 44 associated with the cybersecurity agent 204 monitoring the endpoint client device 36 (Block 280). The micro-cluster data representations 80 representing the micro-clusters are sent to the distributed stream clustering service 30 (Block 282). The cybersecurity agent 204 suspends the stream clustering of the operating system events 200 in response to the model divergence 110 determined using the micro-cluster data representations 80 representing the micro-clusters 84 (Block 284). The cybersecurity agent 204 receives the updated stream clustering machine learning model 82 generated by merging the micro-cluster data representations 80 (Block 286). The cybersecurity agent 204 installs the updated stream clustering machine learning model 82 to the client device 36 (Block 288). The cybersecurity agent 204 resumes the stream clustering of the operating system events 200 using the updated stream clustering machine learning model 82 (Block 290).

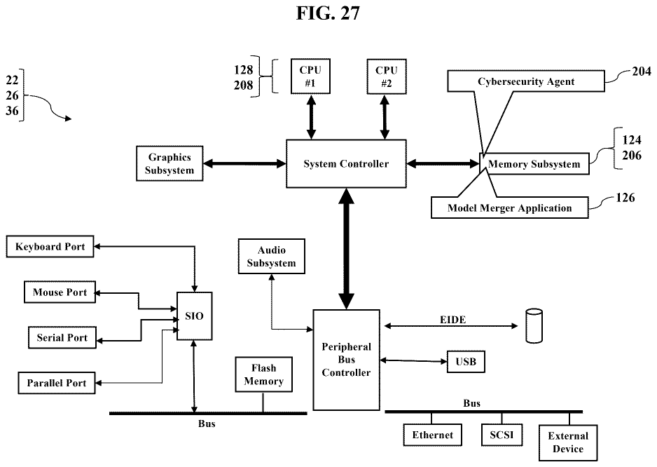

FIG. 27 illustrates a more detailed example of the operating environment. FIG. 27 is a more detailed block diagram illustrating the computer system 22 and the client device 36. The model merger application 126 and/or the cybersecurity agent 204 is/are stored in the memory subsystem or device 124/206. One or more of the hardware processors 128/208 communicate with the memory subsystem or device 124/206 and execute the model merger application 126 and/or the cybersecurity agent 204. Examples of the memory subsystem or device 124/206 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology.

The computer system 22/36 may have any embodiment. This disclosure mostly discusses the computer system 22 as the server 26 and the client device 36. The distributed stream clustering service 30, however, may be easily adapted to mobile computing, wherein the computer system 22 may be a smartphone, laptop or desktop computer, a switch/router, a tablet computer, or a smartwatch. The distributed stream clustering service 30 may also be easily adapted to other embodiments of smart devices, such as a television, an audio device, a remote control, and a recorder. The distributed stream clustering service 30 may also be easily adapted to still more smart appliances, such as washers, dryers, and refrigerators. Indeed, as cars, trucks, and other vehicles grow in electronic usage and in processing power, the distributed stream clustering service 30 may be easily incorporated into any vehicular controller.

The above examples of the distributed stream clustering service 30 may be applied regardless of communications networking technology and networking environment. The distributed stream clustering service 30 may be easily adapted to stationary or mobile devices having wide-area networking (e.g., 4G/LTE/5G/6G cellular), wireless local area networking (WI-FI®), near field, and/or BLUETOOTH® capability. The distributed stream clustering service 30 may be applied to stationary or mobile devices utilizing any portion of the electromagnetic spectrum and any signaling standard (such as the IEEE 802 family of standards, GSM/CDMA/TDMA or any cellular standard, and/or the ISM band). The distributed stream clustering service 30, however, may be applied to any processor-controlled device operating in the radio-frequency domain and/or the Internet Protocol (IP) domain. The distributed stream clustering service 30 may be applied to any processor-controlled device utilizing a distributed computing network, such as the Internet (sometimes alternatively known as the “World Wide Web”), an intranet, a local-area network (LAN), and/or a wide-area network (WAN). The distributed stream clustering service 30 may be applied to any processor-controlled device utilizing power line technologies, in which signals are communicated via electrical wiring. Indeed, the many examples may be applied regardless of physical componentry, physical configuration, or communications standard(s).

Operating environments may utilize any processing component, configuration, or system. For example, the distributed stream clustering service 30 may be easily adapted to execute by a desktop, mobile, or server central/graphical processing unit 58 or chipset offered by INTEL®, ADVANCED MICRO DEVICES®, ARM®, NVIDIA®, APPLE®, TAIWAN SEMICONDUCTOR MANUFACTURING®, QUALCOMM®, or other manufacturer. The computer system 22 may even use multiple central CPUs/GPUs/cores or chipsets, which could include distributed processors or parallel processors in a single machine or multiple machines. The CPUs/GPUs/cores or chipsets can be used in supporting a virtual processing environment. The CPUs/GPUs/cores or chipsets could include a state machine or logic controller. When any of the CPUs/GPUs/cores or chipsets execute instructions to perform “operations,” this could include the CPUs/GPUs/cores or chipsets performing the operations directly and/or facilitating, directing, or cooperating with another device or component to perform the operations.

The distributed stream clustering service 30 may use packetized communications.

When the computer system 22 and the cloud computing environment 24 communicate, information may be collected, sent, and retrieved. The information may be formatted or generated as packets of data according to a packet protocol (such as the Internet Protocol). The packets of data contain bytes of data describing the contents, or payload, of a message. A header of each packet of data may be read or inspected and contain routing information identifying an origination address and/or a destination address.

The distributed stream clustering service 30 may utilize any signaling standard.

The cloud computing environment 24 may mostly use wired networks to interconnect the network members 28. However, the cloud computing environment 24 may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. The cloud computing environment 24 may also utilize other standards, such as the I.E.E.E. 802 family of standards, the Industrial, Scientific, and Medical band of the electromagnetic spectrum, BLUETOOTH®, low-power or near-field, and any other standard or value.

The distributed stream clustering service 30 may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for model merging in distributed stream clustering, as the above paragraphs explain.

The diagrams, schematics, illustrations, and tables represent conceptual views or processes illustrating examples of model merging in distributed stream clustering. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method that clusters streaming data, comprising:
receiving micro-cluster data representations associated with micro-clusters generated by nodes processing the streaming data by executing a stream clustering machine learning model associated with a distributed stream clustering service;
determining a model divergence associated with the stream clustering machine learning model based on the micro-cluster data representations; and
in response to the model divergence, generating an updated stream clustering machine learning model associated with the distributed stream clustering service by merging the micro-cluster data representations.

2. The method of claim 1, wherein the determining of the model divergence further comprises determining a change in a total clusteral count of the micro-clusters.

3. The method of claim 1, wherein the determining of the model divergence further comprises determining a formational clusteral frequency associated with the micro-clusters.

4. The method of claim 1, wherein the determining of the model divergence further comprises determining a clusteral density associated with the micro-clusters.

5. The method of claim 1, wherein the determining of the model divergence further comprises determining a clusteral stability associated with the micro-clusters.

6. The method of claim 1, wherein the determining of the model divergence further comprises determining a frequency of clusteral mergers associated with the micro-clusters.

7. The method of claim 1, wherein the determining of the model divergence further comprises determining a clusteral quality associated with the micro-clusters.

8. The method of claim 1, wherein the determining of the model divergence further comprises determining a change in a total clusteral count of the micro-clusters.

9. The method of claim 1, further comprising:
determining a lifecycle expiration associated with the stream clustering machine learning model based on a global count of the streaming data processed by the nodes; and
in response to the lifecycle expiration, generating the updated stream clustering machine learning model.

10. The method of claim 1, further comprising:
determining a lifecycle expiration associated with the stream clustering machine learning model based on an elapsed time; and
in response to the elapsed time, generating the updated stream clustering machine learning model.

11. A computer system that clusters streaming data, comprising:
at least one central processing unit; and
at least one memory device storing instructions that, when executed by the at least one central processing unit, perform operations, the operations comprising:
sending a stream clustering machine learning model to nodes associated with a distributed stream clustering service;
receiving micro-cluster data representations associated with micro-clusters generated by the nodes parallel processing the streaming data by executing the stream clustering machine learning model;
determining a model divergence associated with the stream clustering machine learning model based on the micro-cluster data representations;
comparing the model divergence to a threshold value; and
in response to the model divergence satisfying the threshold value, generating an updated stream clustering machine learning model associated with the distributed stream clustering service by merging the micro-cluster data representations associated with the micro-clusters generated by the nodes.

12. The computer system of claim 11, wherein the operations further comprise determining a formational clusteral frequency as the model divergence.

13. The computer system of claim 11, wherein the operations further comprise determining a clusteral density as the model divergence.

14. The computer system of claim 11, wherein the operations further comprise determining a clusteral stability as the model divergence.

15. The computer system of claim 11, wherein the operations further comprise determining a frequency of clusteral mergers as the model divergence.

16. The computer system of claim 11, wherein the operations further comprise determining a clusteral quality as the model divergence.

17. A memory device storing instructions that, when executed by a central processing unit, perform operations, comprising:
stream clustering operating system events according to micro-clusters by using a stream clustering machine learning model associated with a cybersecurity agent monitoring an endpoint client device;
sending micro-cluster data representations representing the micro-clusters to a distributed stream clustering service;
suspending, by the cybersecurity agent, the stream clustering of the operating system events in response to a model divergence determined using the micro-cluster data representations representing the micro-clusters;
receiving, by the cybersecurity agent, an updated stream clustering machine learning model associated with the distributed stream clustering service generated by merging the micro-cluster data representations associated with the micro-clusters;
installing, by the cybersecurity agent, the updated stream clustering machine learning model; and
resuming, by the cybersecurity agent, the stream clustering of the operating system events using the updated stream clustering machine learning model.

18. The memory device of claim 17, wherein the operations further comprise determining the model divergence based on a change in a total clusteral count of the micro-clusters.

19. The memory device of claim 17, wherein the operations further comprise determining the model divergence based on a formational clusteral frequency associated with the micro-clusters.

20. The memory device of claim 17, wherein the operations further comprise determining the model divergence based on a clusteral density associated with the micro-clusters.
